(19) United States
(12) Patent Application Publication
(10) Pub. No.: US 2017/0249658 A1
(43) Pub. Date: Aug. 31, 2017

(54) DISPLAYING ESTIMATION OF CONTENT VIEWERSHIP

(71) Applicant: Google Inc., Mountain View, CA (US)

(72) Inventors: Javier Andes Bargas, Zurich (CH); Tim Carlo Jorges, Zurich (CH); Lane P. Shackleton, Mountain View, CA (US); Jason G. Carlin, Mountain View, CA (US)

(73) Assignee: Google Inc., Mountain View, CA (US)

(21) Appl. No.: 14/046,407

(22) Filed: Oct. 4, 2013

(51) Int. Cl. G06Q 30/02

(52) U.S. Cl. CPC G06Q 30/0242

(57) ABSTRACT

An example method includes: obtaining attributes of first content for distribution; identifying second content having the attributes in common with the first content, where the second content was previously distributed; estimating viewership of the first content based on distribution of the second content; estimating, based on distribution of the second content, an effect of the distribution of the first content on viewership of at least the first content that is not directly attributable to the distribution; generating data to display the effect of the distribution of the first content on viewership of at least the first content that is not directly attributable to the distribution; and outputting the data along a path to a computing device.

### TECHNICAL FIELD

This disclosure relates generally to displaying an estimation of content viewership.

### BACKGROUND

The Internet provides access to a wide variety of resources. For example, video, audio, and Web pages are accessible over the Internet. These resources present opportunities for other content (e.g., advertising or non-advertising content, such as audio, video, or the like) to be provided with the resources. For example, a video can include time slots in which content can be presented. Similarly, such slots can be part of television programming.

Slots can be allocated to content providers (e.g., advertisers). In some systems, a network can be used to allocate content to the slots based, e.g., based on various factors relating to the content and the context in which it is to be presented. For example, the content can be allocated based, in part, on keywords input into a system, such as a request for video content. An online content auction can be performed for the right to present advertising in a slot. In the auction, content sponsors provide bids specifying amounts that the content sponsors are willing to pay for presentation of their content. Typically, the one or more winning bidders are given the right to present content. In some cases, the slots may be purchased directly, without going through an auction.

Distribution of online content in slots is typically done in order to increase, e.g., a number of views, awareness, and engagement, of the content. The distribution may also have an effect on other viewership of the content, such as organic views or social views.

### SUMMARY

An example system includes: obtaining attributes of first content for distribution; identifying second content having the attributes in common with the first content, where the second content was previously distributed; estimating viewership of the first content based on distribution of the second content; estimating, based on distribution of the second content, an effect of the distribution of the first content on viewership of at least the first content that is not directly attributable to the distribution; generating data to display the effect of the distribution of the first content on viewership of at least the first content that is not directly attributable to the distribution; and outputting the data along a path to a computing device. The example system may include one or more of the following features, either alone or in combination.

The distribution of the first content may be paid distribution, and viewership of at least the first content that is not directly attributable to the distribution may be attributable to at least one of organic views of the first content and social views of the first content. The data may be used to produce a display that depicts an effect of the distribution on viewership of the first content that is attributable to the distribution, an effect of the distribution on viewership of the first content that is attributable to organic views of the first content, and an effect of the distribution on viewership of the first content that is attributable to social views of the first content.

The example system may also include identifying third content that is related to the first content; and generating may include generating data to display the effect of the distribution on viewership of the third content. The data may be used to produce a display that depicts an effect of the distribution on viewership of the third content that is attributable to organic views of the third content, and an effect of the distribution on viewership of the third content that is attributable to social views of the third content.

The attributes in common may include at least one of: a product associated with the first content, a distribution demographic associated with the first content, a provider of the first content, a distribution mechanism of the first content, and one or more features of a Web page on which the first content is to be displayed. Identifying second content having the attributes in common with the first content may include using a search engine to search an index of content and associated attributes. The first content may be online advertising that is distributed on an online video service. The display may be part of an online process by which an advertiser creates an online advertisement for distribution.

Two or more of the features described in this disclosure/specification, including this summary section, can be combined to form implementations not specifically described herein.

The systems and techniques described herein, or portions thereof, can be implemented as a computer program product that includes instructions that are stored on one or more non-transitory machine-readable storage media, and that are executable on one or more processing devices. The systems and techniques described herein, or portions thereof, can be implemented as an apparatus, method, or electronic system that can include one or more processing devices and memory to store executable instructions to implement the stated operations.

The details of one or more implementations are set forth in the accompanying drawings and the description below. Other features and advantages will be apparent from the description and drawings, and from the claims.

### DESCRIPTION OF THE DRAWINGS

FIG. 1 is an example graph displaying an estimation of content viewership.

FIG. 2 is a block diagram of an example network environment on which the example processes described herein can be implemented.

FIG. 3 is an example process for determining estimations of content viewership and generating a display thereof.

FIG. 4 is an example of a computer system on which the example processes described herein may be implemented.

Like reference symbols in the various drawings indicate like elements.

### DETAILED DESCRIPTION

Content, such as advertising, may be provided to network users based on various factors, e.g., on demographics, keywords, language, and interests. For example, advertising (an “ad”) may be associated with one or more keywords that are stored as metadata along with the ad. An online video service, which operates on the network, may receive input from a user. The input may include one or more of the keywords. A content management system, which serves ads, may receive the keywords from the video service, identify the ad as being associated with one or more of the keywords, and output the ad to the video service, which provides the ad along with the requested content (e.g., video). The content and the ad are displayed on a computing device. When displayed, the ad is incorporated into an appropriate portion of the content. The user may select the ad by clicking-on the ad. In response to selection, typically a hyperlink associated with the ad directs the user to another Web page. For example, if the ad is for ABC Travel Company, the Web page to which the user is directed may be the home page for ABC Travel Company. This activity is known as click-through. In this context, a “click” is not limited to a mouse click, but rather may include a touch, a programmatic selection, or any other interaction by which the ad may be selected.

In some cases, the content (e.g., a video ad) may be displayed prior to requested video content. For example, the video ad may play prior to playing the requested video content. If the ad plays for more than a period of time, or is otherwise interacted with, then the advertiser is charged for display of the video ad. If the user clicks-away from the video ad, and does not otherwise interact with the video ad, before the period of time, the advertiser is not charged for the display.

In some cases, a content auction may be run to determine which content is to be output along with requested video or other information. In the auction, content providers may bid on specific slots or information associated with those slots, such as keywords that are stored in association with video content. The content provider's bid is an amount (e.g., a maximum amount) that the provider will pay for users clicking on their content or for displaying their content to users. So, for example, if a content provider bids five cents per view, then the content provider may pay five cents each time their content is viewed for a period of time, depending upon the type of the auction. In another example, a bidder pays each time one thousand impressions of its content are viewed. In other examples, payment may be on the basis of other actions (e.g., an amount of time spent on a landing page, a purchase, and so forth). In this context, viewing may include, but is not limited to, viewing content for a period of time, interacting with (e.g., clicking-on) that content, distributing the content, endorsing the content, and so forth.

In some cases, slots (e.g., at the beginning of video content) may be purchased directly, without going through an auction. So, for example, an advertiser of camera may directly purchase a slot at the beginning of a video.

In addition to views resulting directly from distribution of content (e.g., ads), the content, or information relating to the content, may be viewed socially, e.g., as a result of social interaction. For example, if the content being distributed is a video about a camera, that content may be viewed according to how the content is distributed, e.g., the content may be viewed prior to display of requested content (e.g., a video about photography). The content may also be viewed due to social interactions with the content. For example, a viewer of the content may share the content online, which can generate views of the content in addition to views that are directly attributable to the initial distribution of the content.

In some cases, content may also be viewed organically. Generally, an organic view is also not directly related to the distribution of the content. For example, a user may identify the content through a subject matter search. The user may then view the content because it was identified as a result of searching, and not because it was distributed along with other content.

Although organic and social views of content are not directly related to the distribution of the content, the amount of organic and social views of the content are typically affected by the distribution of the content. For example, if the distribution is a paid distribution, as is the case in online advertising, the number of social views may increase as more and more users see the paid distribution. In an example, a first user may view the paid distribution and share it with a set of second users. Each of the second users may share the content with a different set of users, and so on, thereby increasing viewership.

In another example, if the distribution is a paid distribution, as is the case in online advertising, the number of organic views may also be affected. For example, searches for the content may reveal additional hits as the content becomes more widely distributed and viewed. Furthermore, viewership (e.g., a number of views) of related content (e.g., content from the same content provider) may increase as a result of viewership of the distributed content. For example, if the distributed content is an advertisement for a camera from manufacturer “A”, a user viewing the distributed content may then search for, and view, related content from manufacturer “A”. In this example, the related content may be camera lenses from manufacturer “A”, or any other related camera equipment. Accordingly, manufacturer “A” receives added organic views of related content (and thus additional value) as a result of the distributed content.

When determining how to distribute content, it is beneficial if content providers have an estimate of the viewership resulting from the distribution and also an estimate of how the distribution will affect organic and social viewership of the content. Accordingly, the processes described herein may be used to estimate, and to display, the effects distributing content (e.g., through paid advertising) have on social and organic viewership of that content or related content. By providing such information, content providers (e.g., online advertisers) may have greater insight into the value that they obtain from content distribution and, therefore, the amount of time and resources to allocate to content distribution.

In an example implementation, the processes identify attributes of first content to be distributed. Example attributes may include, but are not limited to: a product associated with the first content (e.g., a product that is the subject of an advertisement), a distribution demographic associated with the first content (e.g., a demographic to which the first content may be distributed), a provider of the first content (e.g., a manufacturer of the product), a distribution mechanism of the first content (e.g., an online video service), and one or more features of a Web page on which the first content is to be displayed (e.g., multiple related videos on a Web page). Second content is identified which has one or more of the foregoing attributes in common with the first content, and which has been previously distributed. A database (e.g., a search index or other type of database) is then searched (using, e.g., a search engine) to identify viewership of the second content, and to identify what portion of the viewership is directly attributable to distribution (e.g., paid distribution) of the second content and what portion of the viewership is not directly attributable to the distribution. For example, the portion of the viewership that is not directly attributable to the distribution may be attributable to organic and/or social views of the second content. The database may also be searched to identify content that is related to the second content (e.g., of the same product category, of the same manufacturer, of the same advertising campaign, and so forth). Information about the viewership of that related content may also be obtained from the database. For example, viewership of the related content may be identified before and after distribution of the first content, and any spike or increase that is not attributable to other factors (e.g., to newly-launched advertising of the related content) may be attributed to the distribution of the second content.

The information about viewership of the second content may be used to estimate an effect of the distribution (e.g., paid distribution) of the first content on viewership of the first content and, in some cases, content related to the first content. The estimate may indicate, for example, an expected viewership of the first content that is directly attributable to the distribution (e.g., paid advertising). For example, this expected viewership may be obtained using data indicating the number of users who viewed, or otherwise interacted with, second content (e.g., an advertisement) that preceded a video in an online video service.

The estimate may also indicate, for example, an expected viewership of the first content that is not directly attributable to the distribution. For example, the estimate may indicate, an expected viewership of the first content that is attributable to social views. This expected viewership may be obtained from data indicating the number of users who viewed, or otherwise interacted with, second content as a result of users sharing the second content. Information about sharing and other social distribution and viewership of second content may be stored in the database (with appropriate user permission), and that information may be used to estimate viewership of the first content that is attributable to social viewership. Other information not described herein may also factor into the estimation.

The estimate may also indicate, for example, an expected viewership of the first content that is not attributable to organic views. This expected viewership may be obtained from data indicating the number of users who viewed, or otherwise interacted with, second content organically. For example, information about searches and viewership of second content may be stored in the database (with appropriate user permission), and that information may be used to estimate viewership of the first content that is attributable to organic viewership. Other information not described herein may also factor into the estimation.

In some implementations, information about content related to the second content may be factored into the estimation of the organic viewership. In an example like the one above, the second content may be advertising relating to a camera and the content related to the second content (the “related content”) may be advertising relating to lenses for that camera. Information about views of the related content may be stored in the database (with appropriate user permission), and may be correlated to views of the second content in order to identify the effects that viewership of the second content have on viewership of the related content. For example, the database may identify a first user who viewed the second content and then searched for, and viewed, the related content. Other information may also be used to correlate viewership of the second content and the related content.

The estimated viewership of the first content (and, in some examples, related content), including viewership directly attributable to the distribution, social viewership, and organic viewership, may be determined from corresponding estimates of viewership of the second content identified as descried above. For example, in some implementations, viewership identified for the second content may be used as estimates for viewership of the first content. In other implementations, the viewership of the first content may be estimated by processing values for the viewership of the second content using one or more mathematical processes. For example, a multiplier or divisor may be applied to the viewership of the second content to determine the estimate for viewership of the first content.

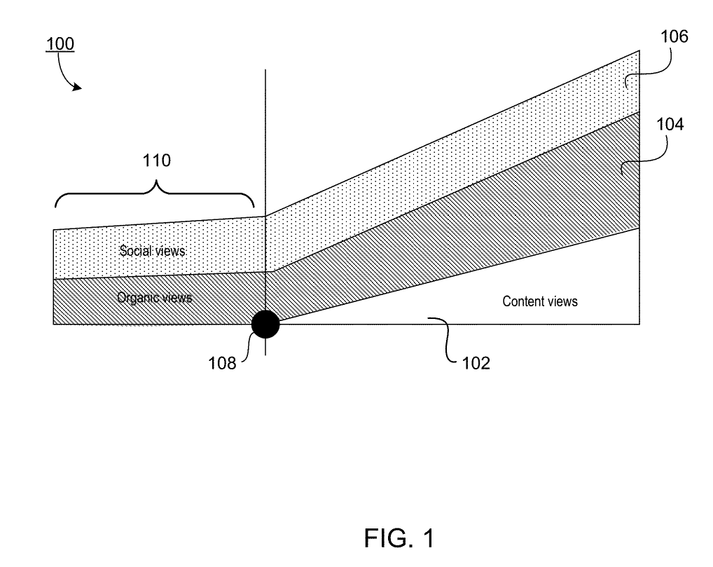

The viewership of the first content may be depicted graphically in a way that reflects the effect of the distribution (e.g., paid advertisement), and the effect of the distribution on viewership that is not directly attributable to the distribution (e.g., organic and social viewership). FIG. 1 shows an example of a graph 100 that depicts content viewership. For example, as shown in FIG. 1, viewership 102 attributable to distribution of the content (e.g., paid advertising) is plotted over time; organic viewership 104 is plotted over the same time; and social viewership 106 is also plotted over the same time. As shown in graph 100, both organic viewership 104 and social viewership 106 grow more quickly and accelerate in their upward growth following the distribution at time 108. In some implementations, as shown in FIG. 1, the content under consideration (including, related content) is in existence 110 prior to the initial distribution at time 108. Viewership of the content prior to the distribution may also be plotted to compare the pre- and post-distribution viewership.

In some implementations, graph 100 is part of an online process by which an advertiser creates an online advertisement for distribution. For example, a prospective advertiser may log into a Web site to create an advertising campaign. The advertiser may then input information about the product being advertised, the demographic for distribution, and so forth. The foregoing processes may then generate a graph of the type shown in FIG. 1 in order to provide the prospective advertiser with an estimate of what to expect from the campaign.

The example process described herein can be implemented in any appropriate network environment, with any appropriate devices and computing equipment. An example of such an environment is described below.

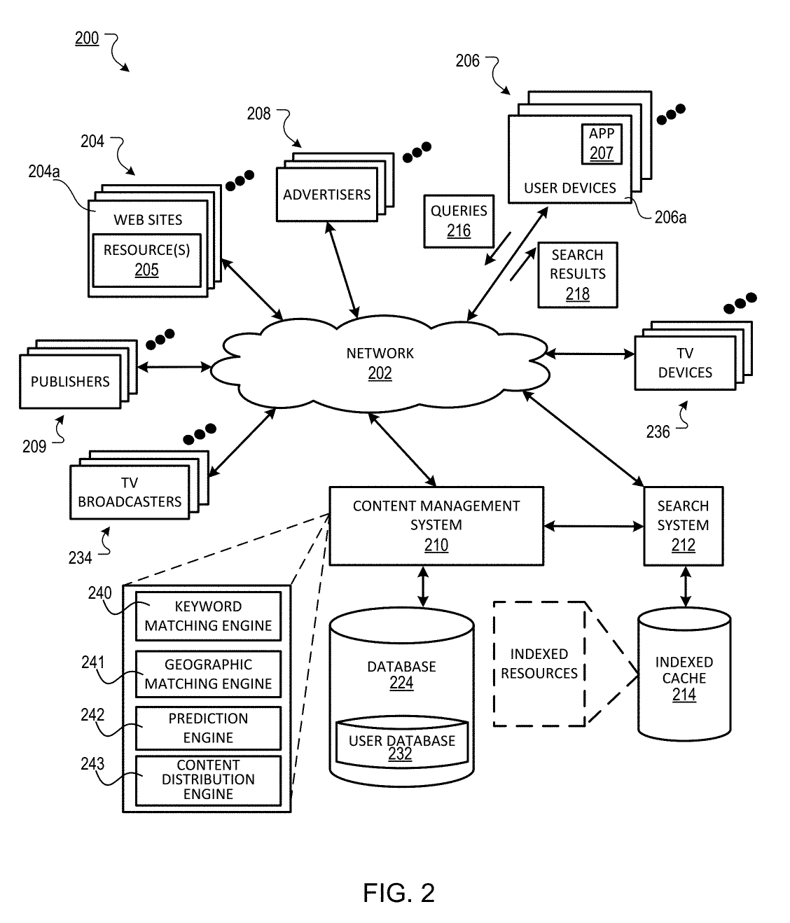

FIG. 2 is a block diagram of an example environment 200 for providing content to a user of a user device and for regulating call-outs as described herein. The example environment 200 includes a network 202.

Network 202 can represent a communications network that can allow devices, such as a user device 206a, to communicate with entities on the network through a communication interface (not shown), which can include digital signal processing circuitry. Network 202 can include one or more networks. The network(s) can provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), or one or more television or cable networks, among others. For example, the communication can occur through a radio-frequency transceiver. In addition, short-range communication can occur, such as using a Bluetooth, WiFi, or other such transceiver.

Network 202 connects various entities, such as Web sites 204, user devices 206, content providers (e.g., advertisers 208), online publishers 209, and a content management system 210. In this regard, example environment 200 can include many thousands of Web sites 204, user devices 206, and content providers (e.g., advertisers 208). Entities connected to network 202 include and/or connect through one or more servers. Each such server can be one or more of various forms of servers, such as a Web server, an application server, a proxy server, a network server, or a server farm. Each server can include one or more processing devices, memory, and a storage system.

In FIG. 2, Web sites 204 can include one or more resources 205 associated with a domain name and hosted by one or more servers. An example Web site 204a is a collection of Web pages formatted in hypertext markup language (HTML) that can contain video, text, images, multimedia content, and programming elements, such as scripts. Each Web site 204 can be maintained by a publisher 209, which is an entity that controls, manages and/or owns the Web site 204. A Web site may host an online video service, through which users may search for, access, upload, download, and view videos.

A resource 205 can be any appropriate data that can be provided over network 202. A resource 205 can be identified by a resource address that is associated with the resource 205. Resources 205 can include HTML pages, word processing documents, portable document format (PDF) documents, images, video, and news feed sources, to name a few. Resources 205 can include content, such as video, words, phrases, images and sounds, that can include embedded information (such as meta-information hyperlinks) and/or embedded instructions (such as JavaScript scripts).

To facilitate searching of resources 205, environment 200 can include a search system 212 that identifies the resources 205 by crawling and indexing the resources 205 provided by the content publishers on the Web sites 204. Data about the resources 205 can be indexed based on the resource 205 to which the data corresponds. The indexed and, optionally, cached copies of the resources 205 can be stored in an indexed cache 214.

An example user device 206a is an electronic device that is under control of a user and that is capable of requesting and receiving resources over the network 202. A user device can include one or more processing devices, and can be, or include, a mobile telephone (e.g., a smartphone), a laptop computer, a handheld computer, an interactive or so-called “smart” television or set-top box, a tablet computer, a network appliance, a camera, an enhanced general packet radio service (EGPRS) mobile phone, a media player, a navigation device, an email device, a game console, or a combination of any two or more of these data processing devices or other data processing devices. In some implementations, the user device can be included as part of a motor vehicle (e.g., an automobile, an emergency vehicle (e.g., fire truck, ambulance), a bus).

User device 206a typically stores one or more user applications, such as a Web browser, to facilitate the sending and receiving of data over the network 202. A user device 206a that is mobile (or simply, “mobile device”), such as a smartphone or a table computer, can include an application (“app”) 207 that allows the user to conduct a network (e.g., Web) search and to view online video. User devices 206 can also be equipped with software to communicate with a GPS system, thereby enabling the GPS system to locate the mobile device.

User device 206a can request resources 205 (e.g., video) from a Web site 204a. In turn, data representing the resource 205 can be provided to the user device 206a for presentation by the user device 206a. User devices 206 can also submit search queries 216 to the search system 212 over the network 202. A request for a resource 205 or a search query 216 sent from a user device 206 can include an identifier, such as a cookie, identifying the user of the user device.

In response to a search query 216, the search system 212 can access the indexed cache 214 to identify resources 205 that are relevant to the search query 216, including, e.g., information about content viewership as descried above, online video, and the like. The search system 212 identifies the resources 205 in the form of search results 218 and returns the search results 218 to a user device 206 in search results pages. A search result 218 can include data generated by the search system 212 that identifies a resource 205 that is responsive to a particular search query 216, and includes a link to the resource 205.

Content management system 210 can be used for selecting and providing content in response to requests for content. Content management system 210 also can, with appropriate user permission, update database 224 based on activity of a user. The user may enable and/or disable the storing of such information. In this regard, with appropriate user permission, the database 224 can store a profile for the user which includes, for example, information about past user activities, such as visits to a place or event, past requests for resources 205, past search queries 216, other requests for content, Web sites visited, or interactions with content. User interests may also be stored in the profile and, in some examples, may be determined from the information about past user activities. In some implementations, the information in database 224 can be derived, for example, from one or more of a query log, an advertisement log, or requests for content. The database 224 can include, for each entry, a cookie identifying the user, a timestamp, an IP (Internet Protocol) address associated with a requesting user device 206, a type of usage, and details associated with the usage. In some implementations, database 224 may be a search index and/or database 224 may be part of indexed cache 214.

Content management system 210 may include a keyword matching engine 240 to compare query keywords to content keywords and to generate a keyword matching score indicative of how well the query keywords match the content keywords. In an example, the keyword matching score is equal, or proportional, to a sum of a number of matches of words in the input query to words associated with the content. Content management system 210 may include a geographic (or “geo-”) matching engine 241 to compare geographic information (e.g., numerical values for place names) obtained from words in input queries to geographic information associated with content. Content management system 210 may also include other engines (not shown) for matching input demographics to desired demographics of an ad campaign, for identifying Web pages or other distribution mechanisms based on content, and so forth.

When a resource 205 or search results 218 (e.g., online video) are requested by a user device 206, content management system 210 can receive a request for content to be provided with the resource 205 or search results 218. The request for content can include characteristics of one or more “slots” that are defined for the requested resource 205 or search results page. For example, the data representing the resource 205 can include data specifying a portion of the resource 205 or a portion of a user display, such as a presentation location of a pop-up window or a slot of a third-party content site or Web page, in which content can be presented. An example slot is an ad slot. Search results pages can also include one or more slots in which other content items (e.g., ads) can be presented.

Information about slots can be provided to content management system 210. For example, a reference (e.g., URL) to the resource for which the slot is defined, a size of the slot, and/or media types (e.g., a video ad preceding requested video) that are available for presentation in the slot can be provided to the content management system 210. Similarly, keywords associated with a requested resource or a search query 216 for which search results are requested can also be provided to the content management system 210 to facilitate identification of content that is relevant to the resource or search query 216.

Based at least in part on data generated from and/or included in the request, content management system 210 can select content that is eligible to be provided in response to the request (“eligible content items”). Content management system 210 can select the eligible content items that are to be provided for presentation in slots of a resource 205 or search results page 218 based, at least in part, on results of an auction, such as a second price auction. For example, for eligible content items, content management system 210 can receive bids from content providers (e.g., advertisers 208) and allocate the content to slots, based at least in part on the received bids (e.g., based on the highest bidders at the conclusion of the auction). The bids are amounts that the content providers are willing to pay for presentation (or selection) of their content with a resource 205 or search results page 218. The selected content item can be determined based on the bids alone, or based on the bids of each bidder being multiplied by one or more factors, such as quality scores derived from content performance, landing page scores, and/or other factors. In other implementations, slots (e.g., time slots preceding selected video) can be purchased directly and not through an auction.

In some implementations, TV (Television) broadcasters 234 produce and present television content on TV user devices 236, where the television content can be organized into one or more channels. The TV broadcasters 234 can include, along with the television content, one or more content slots in which other content (e.g., advertisements) can be presented. For example, a TV network can sell slots of advertising to advertisers in television programs that they broadcast. Some or all of the content slots can be described in terms of user audiences which represent typical users who watch content with which a respective content slot is associated. Content providers can bid, in an auction (as described above), on a content slot that is associated with keywords for particular television content.

Content management system 210 may include an estimation engine 242. Estimation engine 242 may implement all or part of the example processes described herein for estimating, and providing a graphical representation of, content viewership. Content selected for output may be distributed by content distribution engine 243, which is also part of the content management system.

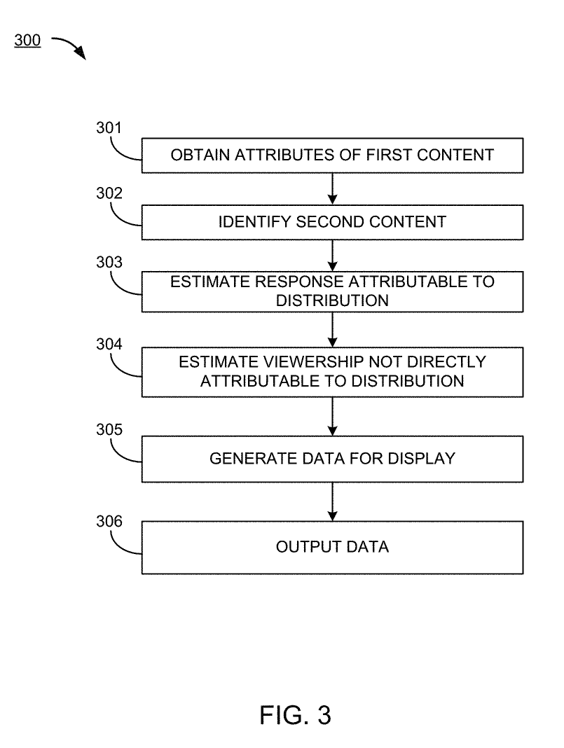

FIG. 3 is a flowchart showing an example process 300 that may be performed by content management system 210 including, at least partly, by estimation engine 242. Process 300 is described in the context of online advertising (“ads”); however, process 300 is applicable to estimating viewership of any appropriate online content or other distributable content.

According to process 300, attributes of first content to be distributed are obtained (301). The attributes may be received from an input submitted by content provider, e.g., into a Web page or other portal. The attributes may include, but are not limited to, a product associated with the first content (e.g., a product that is the subject of an advertisement), a distribution demographic associated with the first content (e.g., a demographic to which the first content may be distributed), a provider of the first content (e.g., a manufacturer of the product), a distribution mechanism of the first content (e.g., via an online video service), and one or more features of a Web page on which the first content is to be displayed (e.g., common features multiple videos on a Web page).

Second content is identified (302) that has one or more of the foregoing or other attributes in common with the first content to be distributed. For example if the first content to be distributed is video advertising relating to a camera made by manufacturer “A”, the second content may be video advertising relating to a camera of similar type and quality made by manufacturer “B”. In this example, the product type “camera” is the same, as are the quality (e.g., a DSLR camera with a $500-plus pricepoint). The second content, unlike the first content, has already been distributed, possibly as part of an ad campaign. Information about the results of the distribution are stored (with appropriate user permission, where applicable) in a database, such as a search index. The information may include viewership of the second content including, but not limited to, viewership directly related to the distribution (e.g. paid advertising), organic viewership, and social viewership.

In some implementations, the second content may also include information about viewership of content that is related to the second content. In the example provided above, this related content may include advertising for lenses made by manufacturer “B” for the camera that is the subject of the second content. When information about related products is included in estimating viewership, the graph of FIG. 1 may be more indicative of the total value of a distribution to a content provider (e.g., the total value of an ad campaign to an advertiser) than when just information about the distributed content is included.

Viewership of the first content that is directly attributable to the distribution (e.g., paid advertising) is estimated (303). This may be done by searching the database (e.g., search index) using a search engine to identify viewership of the second content that is directly attributable to its distribution (e.g., paid advertising). In some implementations, this information is indexed, thereby allowing a user, with appropriate permission, to access the information. The viewership of the first content may be estimated using the viewership of the second content without change, or by processing the viewership of the second content using one or more mathematical processes to estimate the viewership of the first content that is directly attributable to the distribution.

An estimate (304) is made of the effect of the distribution of the first content on viewership of at least the first content that is not directly attributable to the distribution. In this example, viewership of at least the first content that is not directly attributable to the distribution includes, but is not limited to, social viewership and organic viewership. This may be done by searching the database (e.g., search index) using a search engine to identify viewership of the second content that is organic and/or social. In some implementations, this information is indexed, thereby allowing a user, with appropriate permission, to access the information. The viewership of the first content may be estimated using the viewership of the second content without change, or by processing the viewership of the second content using one or more mathematical processes to estimate the viewership of the first content that is organic and/or social.

In some implementations, viewership of content related to the second content, as described above, may be indexed (with appropriate permission), searched, and identified. This information may be used to estimate viewership of content related to the first content. In the example provided above, content related to the second content may include advertising for lenses made by manufacturer “B” for the camera that is the subject of the second content. Information about this related content may be used to estimate social and/or organic viewership of content related to the first content (e.g., lenses of similar type and quality may by manufacturer “A” for the camera that is the subject of video advertising the first content”).

Data is generated (305) to display the effect of the distribution of the first content on viewership of at least the first content that is not directly attributable to the distribution. In this regard, FIG. 1 shows an example of a graph that depicts the effect of the distribution on organic and social views. The graph of FIG. 1 also depicts the viewership resulting from the distribution (e.g., paid advertising). In some implementations, the social and organic viewership may incorporate viewership of related content, such as that described above, to give the content provider a more complete picture of the effects of the content distribution. In some implementations, the social and/or organic viewership of the related content may be identified separately in the graph (which is not the case in FIG. 1).

Data for the display is output (306) along a path (e.g., through one or more networks) to a computing device. The computing device may use the data to generate a display, such as the graph of FIG. 1, that provides the content provider with an indication of the value to be derived from the content distribution (e.g., paid advertising). The advertiser may use this graph in making a determination as to whether or not to pursue a given content distribution (e.g., ad campaign). In other implementations, the information in the graph may be used for other purposes.

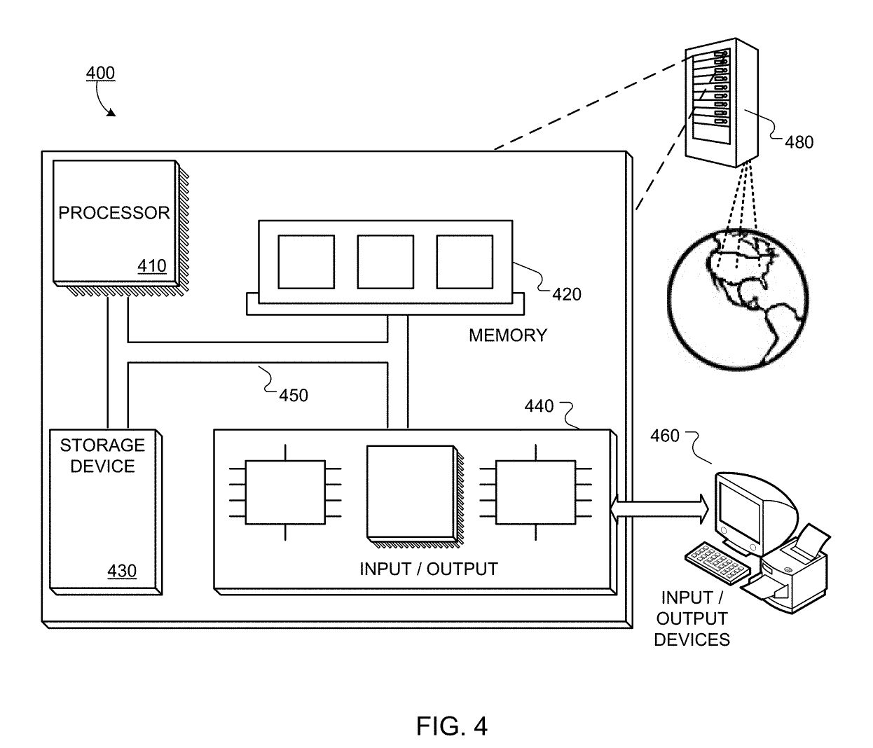

FIG. 4 is block diagram of an example computer system 400 that may be used in performing the processes described herein, including process 300 and its various modifications. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, or some other large capacity storage device.

The input/output device 440 provides input/output operations for the system 400. In one implementation, the input/output device 440 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 460.

The web server, advertisement server, and impression allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Example computer system 400 is depicted as a rack in a server 480 in this example. As shown the server may include multiple such racks. Various servers, which may act in concert to perform the processes described herein, may be at different geographic locations, as shown in the figure. The processes described herein may be implemented on such a server or on multiple such servers. As shown, the servers may be provided at a single location or located at various places throughout the globe. The servers may coordinate their operation in order to provide the capabilities to implement the processes.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

In this regard, various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to a computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be a form of sensory feedback (e.g., visual feedback, auditory feedback, or tactile feedback); and input from the user can be received in a form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or a combination of such back end, middleware, or front end components. The components of the system can be interconnected by a form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Content, such as ads, may be displayed on a computer peripheral (e.g., a monitor) associated with a computer. The display physically transforms the computer peripheral. For example, if the computer peripheral is an LCD display, the orientations of liquid crystals are changed by the application of biasing voltages in a physical transformation that is visually apparent to the user. As another example, if the computer peripheral is a cathode ray tube (CRT), the state of a fluorescent screen is changed by the impact of electrons in a physical transformation that is also visually apparent. Moreover, the display of content on a computer peripheral is tied to a particular machine, namely, the computer peripheral.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating monetizable parameters (e.g., monetizable demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Elements of different implementations described herein can be combined to form other implementations not specifically set forth above. Elements can be left out of the processes, computer programs, Web pages, etc. described herein without adversely affecting their operation. In addition, the logic flows depicted in the figures do not require the particular order shown, or sequential order, to achieve desirable results. Various separate elements can be combined into one or more individual elements to perform the functions described herein.

Other implementations not specifically described herein are also within the scope of the following claims.

1. A method performed by one or more processing devices, comprising:
obtaining attributes of a first item of content for distribution by a content management system via a network to a first plurality of user devices, the first item of content distributed via social distribution at a first rate prior to a first time period and via organic distribution at a second rate prior to the first time period;
identifying a second item of content having attributes in common with the first item of content, the second item of content having been previously distributed via the network to a second plurality of client devices via direct distribution beginning at a second time period and social distribution and organic distribution before and after the second time period;
estimating, by the content management system, viewership of the first item of content based on viewership of the distribution of the second item of content directly attributable to the distribution by retrieving, by a prediction engine of the content management system from viewership statistics in a database, an identification of a subset of views of the second item of content corresponding to the direct distribution of the second item of content beginning at the second time period;
estimating, by the prediction engine based on viewership of the distribution of the second item of content, an effect of the distribution of the first item of content on viewership of the first item of content attributable to social views and organic views and not directly attributable to the distribution by:
determining a first difference between a rate of social views of the second item of content before the second time period and a rate of social views of the second item of content during the second time period,
calculating an estimated rate of social distribution of the first item of content after direct distribution of the first item of content based on the first rate modified by the first difference,
determining a second difference between a rate of organic views of the second item of content before the second time period and a rate of organic views of the second item of content during the second time period, and
calculating an estimated rate of organic distribution of the first item of content after direct distribution of the first item of content based on the second rate modified by the second difference;
generating, by the prediction engine, data to display the effect of the distribution of the first item of content on viewership of the first item of content attributable to social views and organic views; and
outputting the data along a path to a computing device.

2. The method of claim 1, wherein the direct distribution of the first item of content is paid distribution.

3. The method of claim 2, further comprising producing a display depicting an effect of the direct distribution on viewership of the first item of content that is attributable to the direct distribution, an effect of the direct distribution on viewership of the first item of content that is attributable to organic views of the first item of content, and an effect of the direct distribution on viewership of the first item of content that is attributable to social views of the first item of content.

4-5. (canceled)

6. The method of claim 1, wherein the attributes in common comprise at least one of: a product associated with the first item of content, a distribution demographic associated with the first item of content, a provider of the first item of content, a distribution mechanism of the first item of content, and one or more features of a Web page on which the first item of content is to be displayed.

7. The method of claim 1, wherein identifying the second item of content having the attributes in common with the first item of content further comprises searching an index of items of content and associated attributes.

8-9. (canceled)

10. One or more non-transitory machine-readable storage devices storing instructions that are executable by one or more processing devices to perform operations comprising:
obtaining attributes of a first item of content for distribution via a network to a first plurality of client devices;
identifying a second item of content having attributes in common with the first item of content, the second item of content having been previously distributed via the network to a second plurality of user devices;
estimating total viewership of the first item of content based on distribution of the second item of content, comprising viewership attributable to distribution, viewership attributable to social views, and viewership attributable to organic views;
estimating, using the one or more processing devices and based on distribution of the second content, an effect of the distribution of the first item of content on viewership of the first item of content attributable to social views and organic views by:
identifying a growth in a rate of social views or organic views of the second item of content after distribution of the second item of content compared to before distribution of the second item of content, and
applying the growth to a rate of social views or organic views of the first item of content before distribution of the first item of content;
generating data to display the effect of the distribution of the first item of content on viewership of the first item of content attributable to social views and organic views; and
outputting the data along a path to a computing device.

11. A system comprising:
a processor executing a prediction engine, the prediction engine configured for:
estimating viewership of a first item of content directly attributable to distribution of the first item of content based on viewership of a previous distribution of a second item of content directly attributable to the previous distribution of the second item of content by retrieving, by a prediction engine from viewership statistics in a database, an identification of a subset of views of the second item of content corresponding to direct distribution of the second item of content, the second item of content having attributes in common with the first item of content;
estimating, based on viewership of the distribution of the second item of content beginning at a first time period, an effect of the distribution of the first item of content on viewership of the first item of content attributable to social views and organic views and not directly attributable to the distribution by:
determining a first difference between a rate of social views of the second item of content before the first time period and a rate of social views of the second item of content during the first time period,
calculating an estimated rate of social distribution of the first item of content after direct distribution of the first item of content based on a first rate of viewership of the first item of content distributed via social distribution, modified by the first difference,
determining a second difference between a rate of organic views of the second item of content before the second time period and a rate of organic views of the second item of content during the second time period, and
calculating an estimated rate of organic distribution of the first item of content after direct distribution of the first item of content based on a second rate of viewership of the first item of content distributed via organic distribution, modified by the second difference;
generating data to display the effect of the distribution of the first item of content on viewership of the first item of content attributable to social views and organic views; and
outputting the data along a path to a computing device.

12. (canceled)

13. The method of claim 1, further comprising identifying, by the prediction engine from the viewership statistics, a second subset of views of the second item of content corresponding to social views or organic views.

14. (canceled)

15. (canceled)

16. (canceled)
